(19) United States
(12) Patent Application Publication
(10) Pub. No.: US 2013/0110585 A1
(43) Pub. Date: May 2, 2013

(54) Data Processing

(71) Applicants: Andrew Nesbitt, London (GB); Evgeny Shadchnev, London (GB); Robin Landy, London (GB)

(72) Inventors: Andrew Nesbitt, London (GB); Evgeny Shadchnev, London (GB); Robin Landy, London (GB)

(73) Assignee: INVISIBLEHAND SOFTWARE LTD., London (GB)

(21) Appl. No.: 13/287,822

(22) Filed: Nov. 2, 2011

(51) Int. Cl. G06Q 30/02

(52) U.S. Cl. 705/7.35

(57) ABSTRACT

A data processing system comprises a database configured to provide a set of internet addresses of online retailer internet pages for association with respective regular expressions each defining a code string, relative to the code representing the online retailer internet page at the respective internet address, for extracting a product price from that online retailer internet page, and a respective expected price range associated with each online retailer internet page in the set; and a testing system configured to apply the regular expression to its respective online retailer internet page to extract a product price and to detect whether the extracted product price lies within the expected price range corresponding to that online retailer internet page; the testing system being configured, in the case that the extracted product price does not lie within the expected price range, to allocate a different regular expression, from a group of candidate regular expressions, to that online retailer internet page and to repeat the test using successive regular expressions from the group of candidate regular expressions.

### BACKGROUND OF THE INVENTION

1. Field of the Invention

This invention relates to data processing.

2. Description of the Prior Art

Consumer shopping over the internet has grown rapidly in volume over recent years. Almost any product can be bought in this way. With the growth of the overall business, there has been a corresponding increase in the number of retailers offering products for online purchase.

In the case of, for example, specific items of clothing which carry the retailer's label, there might be just one online shop for such items in a particular market (e.g. the United Kingdom market). However, for more common items such as books, CDs and DVDs, there can be many different online shops offering entirely identical products.

This then brings a problem to the consumer: how can the consumer know which is the best source for a particular online purchase?

A partial answer to this question is provided by so-called price comparison websites. These are provided by organisations which cooperate with online shops so as to receive so-called “feeds” of prices from the online shops. The feeds are, in effect, lists of product identifications and corresponding prices at that online shop. By receiving feeds from multiple shops, the price comparison website is able to generate a comparison of prices in respect of any particular item, and display the results of that comparison to a potential purchaser. The price comparison website also provides a hyperlink to the user for at least the lowest priced offering of that item, and possibly for all offerings of that item. This link is embodied as an area within the user's internet browser which is displayed along with an indication that if the user clicks (the term referring to the operation of a user control such as a mouse control to select that link) on the link, the user's browser will be redirected to the exact web page within the selected online shop on which that particular item can be selected for purchase. Typically, a user would make use of such a link if the user did decide to make a purchase: it is a free and convenient service to the user, but for the price comparison website it is very significant because it indicates the origin of the referral to the online store.

Referrals of this type are a major source of income for price comparison websites. Sometimes the online store might pay the referring website a small commission simply for the fact that the potential purchaser has followed a link to that store. This is sometimes known as a “click-through” payment. Also, if the user goes on to make an actual purchase of that item, the online store will typically pay a rather larger purchase commission to the referring website. These commissions do not form a direct cost to the user, in that the user will pay the same to purchase a particular item from a particular online store independent of whether the user entered the store directly or entered via a referring website. The referrals are generally provided as a free service to the user, because the price comparison websites want to encourage the user to enter a store via their referral.

There are at least four problems with price comparison websites of this type.

One is that the prices can be out of date. The pricing relies on feeds from the retailers, which are sent at intervals which are generally measured in days rather than minutes. So the prices may have changed since the last feed, which could mean that a user follows a referral to a particular store only to be disappointed that the actual price is greater than that shown on the price comparison website. Additionally, if one of the retailers lowers their price to become the actual cheapest retailer, but this is not reported by the price comparison site, then the user will be misled as to which retailer is actually selling at the lowest price.

Another problem for the providers of the price comparison websites is that there are now in fact many competing price comparison websites. While it is possible to take steps to try to ensure that a particular price comparison website will emerge as a highly ranked citation in a user search for a product, there remains the problem that user traffic will tend to be divided between several of the competing websites.

Another problem is that price comparison sites require the user to visit them and manually search for the required product in order to locate the lowest prices. Even if the user already knows exactly which product they wish to purchase, it can take considerable time and effort to locate it on the price comparison site.

Another problem is that the consumer can be prevented from accessing retailer prices at price comparison sites and online retailers following the 2007 Supreme Court ruling Leegin Creative Leather Products vs PSKS which enables manufacturers to stop retailers from openly promoting discounted prices. The effect of this ruling on price comparison sites is discussed in Reference 3.

U.S. patent application Ser. No. 12/731,025, listed as Reference 4 below, discloses a price comparison technique in which a web browser is operable to access a list providing one or more groups of internet addresses of online retailer internet pages, each group having two or more internet addresses each relating to different respective retailers' offerings of an item for purchase, so that if information derived from a current internet address being accessed by the web browser relates to such a group of internet addresses, the other internet addresses in the group are returned as alternative internet addresses relating to a current item being viewed.

The web browser can detect a retail price of the current item from each of the internet addresses in the group containing the current internet address, compare the retail prices and indicate the lowest such retail price for the current item while displaying the internet page relating to the current internet address. That technique allows price comparisons to be generated in real time, at the very time that the user is looking at an item for purchase, without the user having to look at a separate price comparison website to obtain the information.

However, the technique of Reference 4 relies on the accurate detection, from a currently viewed internet page, of the product that the user is currently viewing.

It is an object of the present invention to provide an improved technique for providing price information to potential purchasers.

### SUMMARY OF THE INVENTION

This invention provides a data processing system comprising: a database configured to provide a set of internet addresses of online retailer internet pages with respective regular expressions each defining a code string, relative to the code representing the online retailer internet page at the respective internet address, for extracting a product price from that online retailer internet page, and a respective expected price range associated with each online retailer internet page in the set; and a testing system configured to apply the regular expression to its respective online retailer internet page to extract a product price and to detect whether the extracted product price lies within the expected price range corresponding to that online retailer internet page; the testing system being configured, in the case that the extracted product price does not lie within the expected price range, to allocate a different regular expression, from a group of candidate regular expressions, to that online retailer internet page and to repeat the test using successive regular expressions from the group of candidate regular expressions.

Although exemplary embodiments of the client device are described below in the context of a client computer, it should be understood that the client device may be any type of internet-connectable data processing arrangement, such as a personal computer, a mobile telephone, a personal digital assistant, a games machine and the like. Other respective aspects and features of the invention are defined in the appended claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 schematically illustrates three computers connected via the internet;

FIG. 2 is a schematic flow diagram illustrating an online shopping operation;

FIG. 3 is a schematic flow diagram illustrating a price scraping operation;

FIG. 4 represents a portion of html code relating to a notional shopping web page;

FIG. 5 schematically illustrates a part of a user's screen display;

FIG. 6 is a schematic flow diagram illustrating the initiation of a regex testing process;

FIG. 7 is a schematic flow diagram illustrating a regex testing and repair process;

FIG. 8 is a schematic flow diagram illustrating a regex downloading process;

FIG. 9 is a schematic flow diagram illustrating a referral payment arrangement;

FIG. 10 is a schematic flow diagram illustrating a product identification process;

FIG. 11 is a schematic flow diagram illustrating a price comparison process relating to search results; and

FIG. 12 is a schematic flow diagram illustrating a process for handling failed price scraping operations.

### DESCRIPTION OF THE PREFERRED EMBODIMENTS

In the following description, any references to web addresses represent hypothetical examples only, unless otherwise indicated.

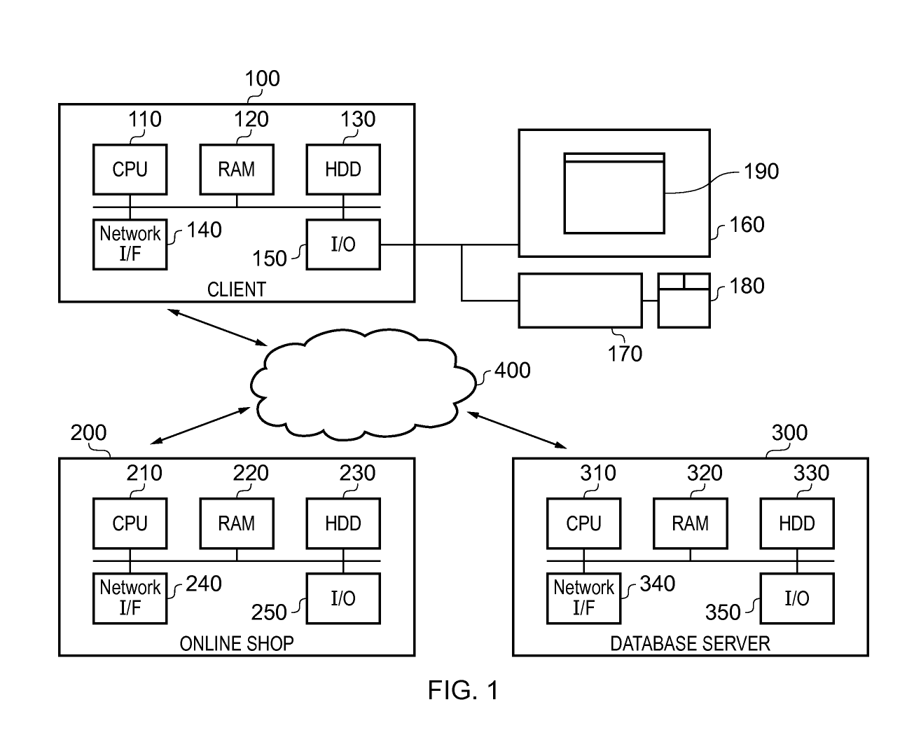

FIG. 1 schematically illustrates three computers connected via the internet. These are schematic representations of three types of computer that will be discussed in the description below. The three types are: a client computer 100, an online shopping server 200 and a database server 300 which may be provided as a part of the functionality of a more general web server. The three are linked via an internet connection 400.

It should be understood that the term “client computer” may refer to any type of internet-connectable data processing arrangement, such as a personal computer, a mobile telephone, a personal digital assistant, a games machine and the like.

At a high level, the three computers share features in common. That is to say, each of the computers has one or more central processing units (CPUs) 110, 210, 310; memory storage shown schematically as random access memory (RAM) 120, 220, 320 (though various types of memory could be provided); non-volatile storage shown schematically as a hard disk drive (HDD) 130, 230, 330 (though other types of non-volatile storage such as flash memory could be provided); a network interface 140, 240, 340; and an input/output (I/O) controller 150, 250, 350. The client computer is shown as being connected, via the I/O controller 150, to a display screen 160, a keyboard 170 and a user input device such as a mouse 180. Similar devices may be connected to the online shopping server 200 and to the database server 300.

Each of the computers runs software in order to carry out its operations. The software may be stored on the HDD 130, 230, 330 and/or in the RAM 120, 220, 320, and may be provided via a removable storage medium (not shown) such as an optical disk, via a network or internet connection or otherwise.

Specifically, the client computer runs at least a software application known as a web browser 190. A web browser is a computer program for retrieving, presenting and traversing information resources on the World Wide Web. Examples of known web browsers include the Microsoft® Internet Explorer®, Mozilla™ Firefox™, Google® Chrome™ and Apple® Safari™ browsers. The web browser is shown schematically in FIG. 1 as a display window, but it will of course be appreciated that a piece of running software on the computer 100 will interact with the CPU, the RAM, the HDD, the network interface and the I/O controller as well as with the display screen, keyboard and mouse. In the present example, the web browser 190 is the Mozilla Firefox web browser, though any of the browsers described above, or another browser, could be used.

At the date of filing, the Mozilla Firefox web browser is provided to users free of charge by a downloading process over an internet connection. That is to say, a Mozilla server computer (not shown) holds a copy of an installation package for the Mozilla Firefox web browser. A client computer can connect via the internet to the Mozilla server computer and retrieve a copy of the installation package over its internet connection. The installation package is then used locally at the client computer to install the Mozilla Firefox software onto the client computer.

Once this installation process has been done, the software is present and ready to run on the client computer in a basic form. This form allows basic web browsing operations to be performed. However, the functionality of the web browser software can be increased by installing so-called add-ons such as “extensions” or “plug-ins” to the basic form of the web browser software. For simplicity these will be generically referred to below as “extensions”.

Extensions comprise additional software which can be used to modify the behaviour of existing features of the base application or to add entirely new features. Extensions are especially popular with the Mozilla Firefox web browser, because the browser software itself was designed to be minimalist and compact, but with an easy route to add extensions, so allowing users to customise the software to provide the exact functions they require. Some of the techniques used to provide extensions are described in Reference 1. Extensions can be made available to the public for wide (and generally free) access, by placing them within a directory of extensions overseen by Mozilla. In this way, a user can access the set of available extensions by operating a command from within the basic Firefox web browser. Once the user selects a desired extension, the directory provides an automatic link to a server holding software relating to that extension so that the user can download (retrieve) that extension and install it on the user's client computer.

In the present embodiment, the specific functionality described below which is not part of the basic functionality of the Mozilla Firefox web browser (or indeed of any other of the browsers mentioned above) is provided by one or more extensions which the user can download and add to the basic Mozilla Firefox program. Once the extension has been installed, it interacts with the client computer as though part of the overall browser software. The main distinctions between the base browser software and an installed extension are to do with the respective sources of the software and the fact that an extension can be removed at the option of the user without necessarily removing the basic functionality of that browser. So, it could be considered that the composite software (the basic browser software plus the extension) simply represents another example of browser software—in many ways the separation of “base” and “extension” software in respect of an installed extension is a slightly artificial one. Indeed, sometimes the functionality of popular extensions is incorporated into future releases (versions) of the base software.

Turning now to the online shopping server and the database server, at a high level these computers are generally similar to the client computer, though they are likely to have greater processing, storage and communication resources to allow them to interact with multiple client computers at the same time.

The online shopping server stores a database of products for sale, with each product having associated price, availability and description data. The online shopping server may also operate software dealing with payments and transactions. All of the software used on a typical online shopping server is well known to the skilled person at the date of the present application. In use, in order to make a purchase or to view products on the online shopping server, the user of the client computer directs his web browser to the base web address of the online shopping server. The client computer connects to the online shopping server and the user is provided with various options such as hyperlinks or search systems to move around (“navigate”) from page to page within the set of web pages held by the online shopping server. Here it is noted that with few exceptions, online shopping servers operate so that each product for sale has at least one respective web page.

Only one online shopping server is shown in FIG. 1, for clarity of the diagram. In fact, of course, very many competing online shopping servers exist. Generally speaking, a user can buy the same product from many different sources, often at different respective prices.

The database server 300 is established to interact with extension software running on a client computer. At a basic level, the database server stores a database of web (internet) addresses, otherwise referred to as URLs (uniform resource locators). An example of a URL is the web address giving information relevant to Reference 1 below.

In general terms, the database server provides a database configured to provide a set of internet addresses of online retailer internet pages, which can be associated with respective regular expressions each defining a code string, relative to the code representing the online retailer internet page at the respective internet address, for extracting a product price from that online retailer internet page, and a respective expected price range associated with each online retailer internet page in the set. The set of regular expressions and expected prices can be sent, for example, once a day, on start-up of the browser, as a so-called “push” transfer from the database server (that is, a transfer initiated by the database server and automatically accepted by the browser) and so on. These features will be discussed further below.

In some embodiments of the present invention, the database server stores multiple groups of URLs, with each group having two or more URLs, so that the URLs in a single group each relate to a respective retail offering of the same product. This arrangement in which the groups are pre-prepared will be described in greater detail below. In other embodiments, the database server generates a group of URLs relating to a product when required to do so in response to a request from a client computer. This “on the fly” preparation of a group will also be described below.

The database server operates so as to receive a query from a client computer in the form of a URL under test. The database server either generates a group of URLs relating to other retailers' offerings of the same product (in the “on the fly” system), in which case the group is returned in response to the query, or establishes whether that URL exists within one of the pre-prepared groups of URLs held by the database server. In the latter case, if it does exist within a group and the number of URLs in that group is below a threshold value (e.g. 30 URLs) it returns the other URLs within that group as a response to the client computer which initiated the query. Groups containing a very large number of URLs are likely to contain many invalid matches. The threshold value used in the pre-prepared group system is set to prevent these URLs from being “scraped” (see below) and an invalid notification being shown.

In the various embodiments, the URLs can be generated, stored and handled in a normalised form. Normalisation of URLs is described below.

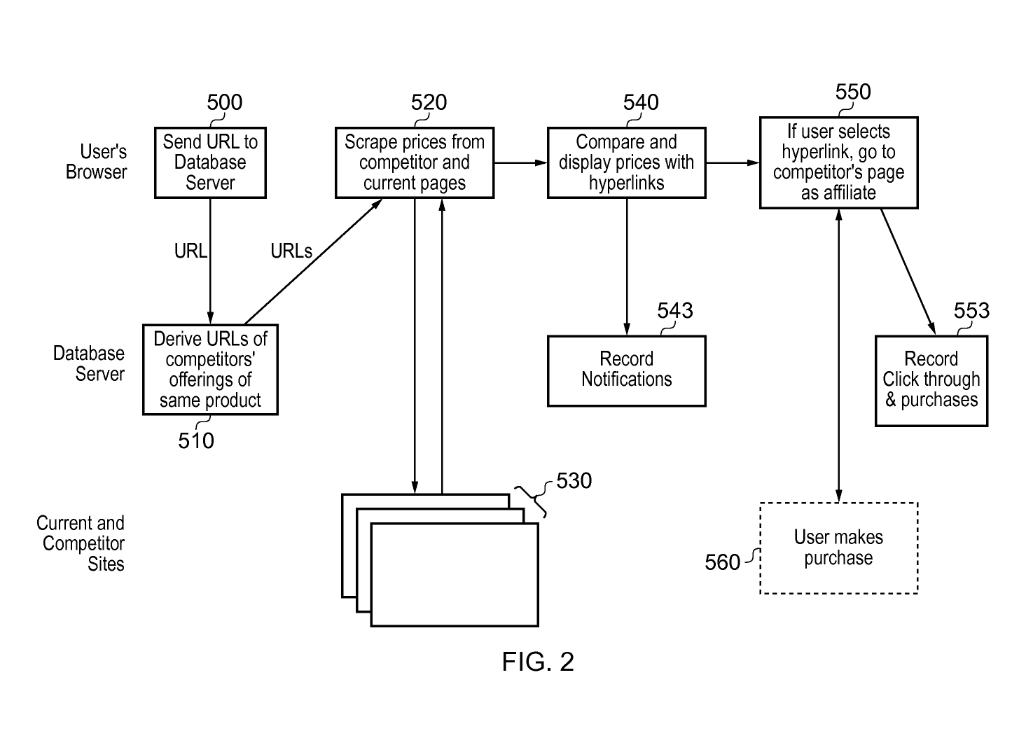

FIG. 2 is a schematic flow diagram illustrating an online shopping operation according to an embodiment of the present invention. The diagram relates to an attempt at online shopping by a user of the client computer, which starts with the user viewing a product on a particular online shopping server. The diagram is arranged as three rows, where each row relates to functions provided by a different computer or computers. In particular, the top row illustrates functions provided by the user's browser on the client computer, the middle row illustrates functions of the database server, and the bottom row illustrates functions provided by competitor online shopping servers (i.e. online shopping servers other than the online shopping server which the user is currently browsing) and the online shopping server which the user is currently browsing.

So, the process starts with the user using the web browser 190 of his client computer 100 to view a product at a particular online shopping server. At a step 500, the user's web browser sends the URL of the currently viewed page to the database server 300.

At a step 510, the database server either (a) generates a group of URLs relating to competing offerings of the same product and (if any such URLs are identified) returns them to the client computer as a response, or (b) detects whether the URL which it receives from the client computer is present in a group of URLs held in the database by the database server. In the latter case, if it is not present, the database server sends a negative reply to the client computer. In addition, if the URL is not present in any group, the server may try to find alternative URLs anyway, for example by contacting a preselected major shopping site and searching for that product there. However, if it is present in one of the groups, the database server replies to the client computer with the other URLs in that group.

The URLs in a group (as stored by the database server under the “pre-prepared” system or in a group generated “on the fly” by the database server) correspond to different offerings of the same product. So, for example, two schematic groups of URLs are shown in the following table. In reality, the database server might be capable of handling many thousands of groups, each comprising perhaps of the order of two to thirty or more URLs.

Where the groups are pre-prepared, the groups can be populated (at least initially) from feeds provided by the online retailers. Here, it is simply necessary to match the feeds together, that is to say, to identify that a URL in a feed from one retailer relates to the same product as a URL from a feed from another retailer. This match may be carried out using a unique product identifier such as a barcode number or an ISBN (International Standard Book Number). Feed-based matching can also be achieved using non-unique identifiers i.e. MPNs or product titles.

The examples shown in the tables below can be in a format as sent from the database server to the client, but in embodiments of the invention this is the form that the data takes as assembled by the client. That is to say, the client receives the Regex data (and optionally the price range data) from time to time (such as once a day, at browser start-up, as a push transfer), but receives the URLs for a product group in response to a specific request relating to a current online shopping activity by the browser user. The client can, at that stage, associate the URLs returned by the database server with the Regex and price information which it already holds.

| | | |
|---|---|---|
| Group 1 | | |
| URL for product 1 at online shop 1 | Regex for this URL | Expected price range for URL |
| URL for product 1 at online shop 2 | Regex for this URL | Expected price range for URL |
| URL for product 1 at online shop 3 | Regex for this URL | Expected price range for URL |
| URL for product 1 at online shop 4 | Regex for this URL | Expected price range for URL |
| . . . | . . . | . . . |
| . . . | . . . | . . . |
| Group 2 | | |
| URL for product 2 at online shop 1 | Regex for this URL | Expected price range for URL |
| URL for product 2 at online shop 3 | Regex for this URL | Expected price range for URL |
| URL for product 2 at online shop 5 | Regex for this URL | Expected price range for URL |
| URL for product 2 at online shop 6 | Regex for this URL | Expected price range for URL |
| . . . | . . . | . . . |
| . . . | . . . | . . . |

At a basic level, the database server does not need to carry or provide, as the case may be, any information about the products themselves, just a list of URLs which relate to the same product, an associated regular expression (Regex) for price scraping from that URL (see below), and optionally, for use in the Regex repair arrangement to be described below, an expected price range for the product represented by that URL. As mentioned above, these could be provided at the same time, or the browser could have been pre-provided with the Regex and price information. However, in other embodiments to be described below, the database server might also carry or provide additional information about the products themselves.

In the examples, it can be seen that the set of online shops offering product 1 is different to the set of online shops offering product 2. In general, each product is independent of the others and there is no requirement that the set of shops offering one product need have anything in common with the set of shops offering another product. However, in practice there is likely to be a set of shops which all offer (for example) DVDs, and so many DVD products may result in groups of URLs being returned by the database server in response to a client query which cover substantially the same set of shops.

The database need not store any groups which have only one URL. A main purpose of the database is to reply to a query from a client computer by providing URLs of competing offerings of a certain product for association with respective Regexes, so in some embodiments, groups of only one URL are not stored at all in the database. In other embodiments, such groups may be stored, in order to act as a placeholder in case further URLs relating to that product are discovered. In this situation a reply would still be sent to a client computer which has queried the single URL in such a group to confirm there were no other URLs in the group. Note that the database server 300 can provide the Regexes (for the URLs returned in response to a client computer's query) as part of the specific response to that query. In other words, each URL can be returned so as to be associated with a Regex. As an alternative, and as described below with reference to FIG. 8, the database server 300 can provide a list of URLs and Regexes to the web browser for later use. As an example, such a list may be provided as part of an initialisation procedure when the web browser is started by the user, thus ensuring that the list of Regexes is frequently updated at the web browser. Then, only the URLs relating to a query need to be returned in response to that query; the web browser consults the list of Regexes already provided by the database server to establish how to scrape prices from each of those URLs. However, the overall result is that the browser receives URLs and corresponding Regexes from the database server. Note also that different respective sources may provide the Regex list and the set of URLs returned in response to a query, but for simplicity of the explanation they are both described here as being provided by the database server.

Any individual URL in the database is found in only one stored group. If a URL were in two groups, those groups would be amalgamated to form a single composite group.

The “pre-prepared” example described above involves URLs in the database being grouped together by a matching algorithm, in advance of receipt of a search query, into groups of URLs representing offerings of the same product by different retailers. Doing this grouping in advance has the advantage that the data is ready for quick access when required. However, it means that it is expensive and time consuming to make improvements to the matching algorithm. In particular, a change to the algorithm requires the entire database to be re-indexed, which could potentially take weeks and would be difficult to reverse.

An alternative, therefore, is the “on the fly” system in which the product matching is applied in real time. In one embodiment, a URL received as a query is matched to other URLs in the database when the query is received. This makes use of product information held in association with each URL in the database. This means that significant data processing resources are required at the database server to achieve this real time matching, but it also means that the matching algorithm can be developed and changed much more easily; once a change has been implemented, it is possible to monitor whether the revised algorithm has led to any improvements in matching accuracy within a short time, just by monitoring user activity with respect to the notifications that they receive. In another embodiment, the URLs relating to competing offerings of the product in question can be constructed using rules obtained from the retailers or alternatively gleaned from an examination of the format of retailer URLs. For example, a retailer “test_webshop” may be found to use URLs in the form:

www.test_webshop.com/product=MPN

or www.test_webshop.com/manufacturer=Sony&model=DSCW530

where MPN is the manufacturer's product number and “Sony DSCW530” is the manufacturer's name and model number. In such cases, a URL relating to test_webshop may be constructed by the database server from rules defining one of these formats of URL, along with the MPN or the product manufacturer and name.

Another common format is to use arbitrary, retailer-specific, identification codes or numbers. The retailer codes may be substantially meaningless (as an apparently arbitrary string of characters) to human readers. An example is in the form:

www.test_webshop.com/product=retailer_code

or www.test_webshop.com/retailer_code

Note that it is common for online retailers to provide multiple links into their retail pages. If a purchaser clicks on an advertisement on the retailer home page for a particular camera (for example), the URL as seen by the purchaser at the top of their browser might be quite descriptive, for example:

www.test_webshop.com/cameras/Sony/compact/black/model=DSCW530

However, the retailer's website may be set up so that exactly the same page may be accessed by the following URL:

www.test_webshop.com/model=DSC530

or www.test_webshop.com/A12345XYZ

These shortened forms of links can be established using information provided by the retailer or empirically by the database server, possibly using a look-up table established and/or maintained by the database server, listing products against retailer codes. For example, as part of establishing the data from which URLs are subsequently generated, the database server could navigate to the web_shop site and to the public URL for the page relating to the Sony 0 DSCW530™ camera:

www.testwebshop.com/cameras/Sony/compact/black/model=DSCW530

The database server can then delete successive parts of this URL in such a way that the model number (DSCW530) is deleted last, and check whether, after each such deletion, the URL still navigates to the same required page. In this way, the database server can establish that the shortened form of the URL works correctly:

www.test_webshop.com/model=DSCW530

In a real example, at the date of filing the following two pairs of URLs point to the same pages at the respective online retailer on which the Sony DSCW530 camera is sold. An example using the seller's retailer code (B004I5C3Z8 in this example):

http://www.amazon.co.uk/gp/product/B004I5C3Z8/

http://www.amazon.co.uk/gp/product/B004I5C3Z8/ref=s9_bbs_gw_d0_g23_ir04?pf_rd_m=A3P5ROKL5A1OLE&pf_rd_s=center-&pf_rd_r=0EJBPC8VNNCKYWHS32WQ&pf_rd_t=101&pf_rd_p=467128533&pf rd_i=468294

And an example using the product name (Sony DSCW530):

http://www.currys.co.uk/Sony_DSCW530

http://www.currys.co.uk/gbuk/sony-cyber-shot-dsc-w530-compact-digital-camera-silver-09621412-pdt.html?srcid=198˜Photography˜09621412&cmpid=ppc˜gg˜UFC-Camera˜09621412˜LT&mctag=gg_goog_{—}7904_&gclid=CN_Ort_viqwCFYYe4QodelucnQ

Using these techniques, the database server can establish a set of rules which allow the database server to build URLs “on the fly” using the product number and/or name scraped from the page which the purchaser is currently viewing. In some embodiments, the client computer sends this information as part of the query transmitted to the database server. In other embodiments, the database server can scrape the required data (to allow the database server to build the other URLs) by itself navigating to the URL supplied by the client computer.

This generation of the URLs relies on knowing which Regex to use in respect of each generated URL, and so works well with online stores which can respectively be scraped using a standardised and simple Regex or small group of Regexes.

As one further step, the database server (or the client web browser, discussed below) may, in embodiments of the invention, add a “referrer” or “affiliate” identification. The use of this information, to identify the source of the referral to the online retailer, will be discussed further below. An example of a referrer identification included in the URL constructed as discussed above might be:

www.test_webshop.com/model=DSCW530&referrer=ih

Returning to the step 510 of FIG. 2, the processing proceeds on the assumption that the query sent by the client computer has resulted in a group of two or more URLs being identified in the database, in which case the database server returns the other URLs in that group (that is, not including the URL which formed the original query) to the client computer; or that the query resulted in the database server generating one or more competing URLs and sending those competing URLs to the client computer.

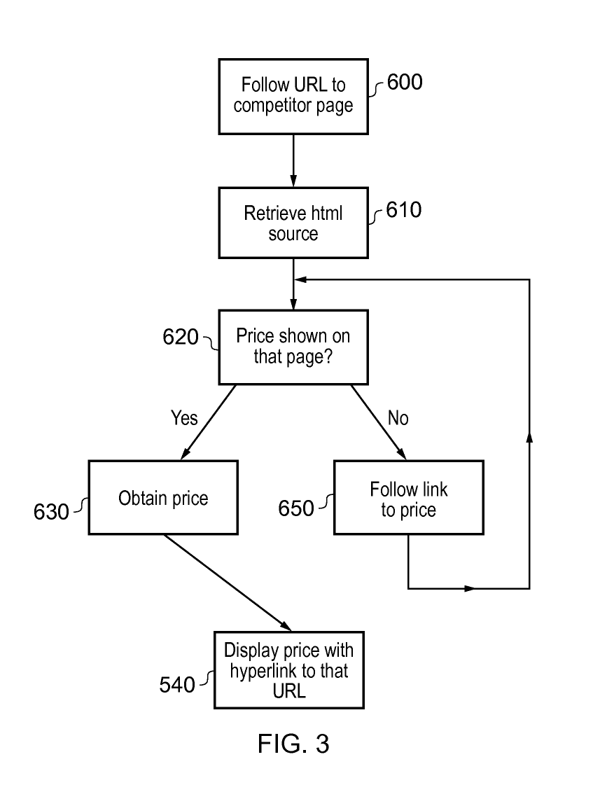

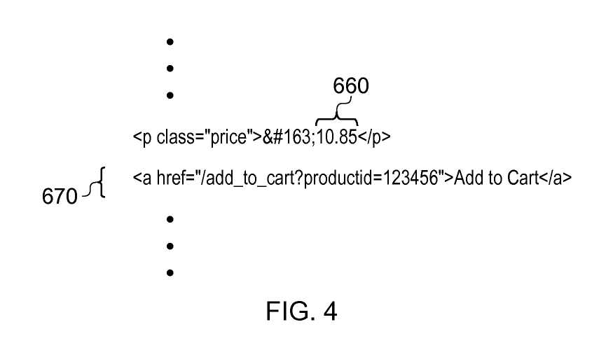

At steps 520 and 530, the web browser of the client computer “scrapes” prices for the current product from the online shop which is currently being viewed by the user and from the competitor online shopping servers identified by the URLs returned by the database server. Price “scraping” refers to an automated software process of identifying the price of a particular product from the web page on which that product is offered for sale. This process will be described below in more detail with reference to FIGS. 3 and 4. For now, it is sufficient to say that the price scraping process provides to the web browser of the client computer numerical data representing the price of the current product at the current online shopping server and at each of the URLs identified in the reply from the database server.

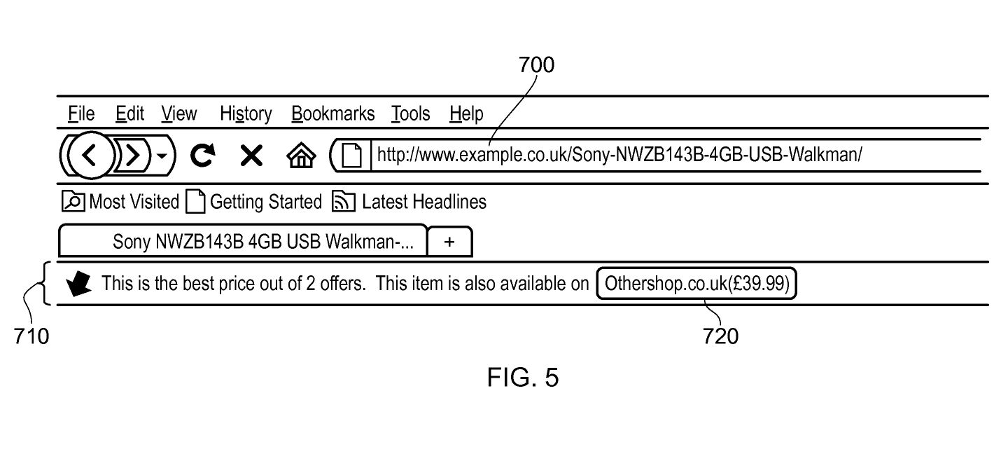

At a step 540 the web browser of the client computer compares the numerical price data and displays information to the user relating to the prices and, if appropriate, hyperlinks to the competitor web pages offering that same product. Examples relating to the step 540 will be discussed below with reference to FIG. 5. The web browser of the client computer also sends a message to the database server so as to allow the database server to keep a record (at a step 543) of the notifications provided to the user (that is to say, the competitor prices and hyperlinks) as part of the operation of the step 540.

Significantly, the price information shown at the step 540 is completely up to date, having been freshly obtained, on demand, at the time of display.

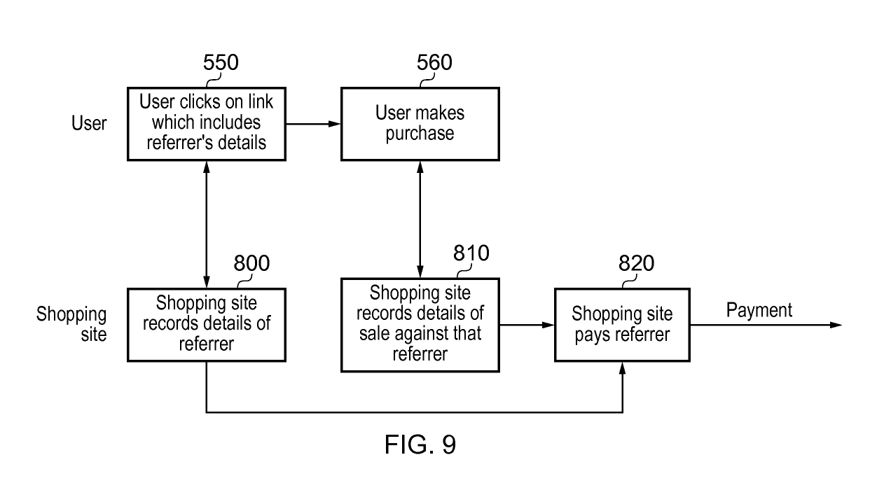

At a step 550, if the user selects one of the hyperlinks to a competitor's web page, the web browser connects to that web page. The connection identifies the source of the referral of the user to that web page, which in this example means that the connection identifies the provider of the extension software providing the functionality of steps 500, 520, 540 and 550 (which would generally be the same as the provider of the database server giving the functionality of the step 510). The link to the competitor's site is therefore made with the extension provider as an “affiliate” of the competitor's online shopping service in order to earn payment from that shop. The nature of this affiliation will be described below with reference to FIG. 9. The example affiliate process is described here and in FIG. 9 as being operated by the retailer. This is true for retailers who have their own affiliate scheme, but there are other options.

For example, other affiliate schemes may be operated by “affiliate networks” acting as middle-men between the referrer and the retailer. The affiliate network usually tracks clicks-through and resulting sales. The affiliate network usually pays the referrer (in this case, the provider of the extension software) rather than the retailer paying the referrer. Additionally, the affiliate link may actually be an intermediary or ‘redirect’ URL which enables the affiliate network to record the referrers click and then triggers a second URL which takes the user to the relevant page at the retailers site. Importantly, because the functionality described here is provided as part of a web browser, it is not necessary for the user to make a special effort to choose to look at a price comparison site (of which there are many). Instead, the opportunity to earn affiliate payments is always present, because the web browser will be in use, and the current operations will be carried out as a background process, whenever the user is carrying out online shopping.

An example of a technique for identifying the source of the referral is, as mentioned above, to append a referrer identification to the URL, for example appending “&referrer=ih”, where “ih” is a code indicating a particular referring entity.

Finally, at a step 560, the user might make a purchase of the item from the competitor's website. This is carried out in a conventional way, with the extension provider as an affiliate.

At a step 553, the database server records data relating to clicks-through by the user (that is to say, the user following one of the hyperlinks provided as a notification at the step 540) and/or purchases made by the user.

The steps 520 and 530 referred to a price scraping operation. Of itself, basic price scraping is a known technique, but for completeness, and to introduce some aspects of price scraping which go beyond the conventional use of the term, it will now be described. FIG. 3 is a schematic flow diagram illustrating a price scraping operation and FIG. 4 represents a portion of html code relating to a notional shopping web page.

Referring to FIG. 3, at a step 600 the client computer's web browser follows a URL (as provided by the database server) to a competitor's web page offering the same product as the product which the user is currently viewing. This is done as a background process, on receipt of the competitor URL from the database server. This background process is invisible to the user and if it fails, the user is not notified about it.

At a step 610 the web browser retrieves the html (hypertext markup language) source script which defines the competitor's web page. In general, a web page which presents an attractive visual offering of a product to the user is defined by a long series of html commands which define the layout of the web page including text, images and hyperlinks to appear on the web page. A small portion of an example html script relating to a web page by a hypothetical online shop called “exampleseller.com” offering a DVD for the film “Dorian Gray” for sale is shown in FIG. 4.

At a step 620 the web browser detects whether a retail price is shown on the retrieved page. The web browser achieves this by maintaining and consulting a small database of identifiable patterns within the html code used by the set of online shops covered by the URLs held by the database server. The entries in this database are generated manually (by inspecting html code of online shops' web pages) by the operators of the database server 300 and is passed to the web browser as a regular update (e.g. at start-up of the web browser, or once a week). Alternatively, of course, the information could be returned by the database server with the URLs at the step 510, though such an arrangement could increase network traffic and tend to slow down the response of the system.

An example entry in the database referred to in the preceding paragraph is as follows:

| Online shop | Identifiable pattern |
|---|---|
| exampleseller.com | <p class=“price”>DVD &#163;[$price_exampleseller.com] |

where the string <p class=“price”>DVD &#163; when found in the html script identifies that the numerical value immediately following that string indicates the price of the item, which is stored by the web browser as the variable $price_exampleseller.com. In the example shown in FIG. 4, the presence of this string is marked in FIG. 4 as a price 660 and is identified as £10.85.

The way in which the identifiable patterns are detected and maintained will be described in more detail below with reference to FIGS. 6 to 8.

Returning to FIG. 3, if the step 620 identifies that a price is shown on that web page, the price is retrieved at a step 630 and is temporarily stored by the web browser 190. Control then passes to the step 540 of FIG. 2 to display that price and a hyperlink to that web page.

If however the step 620 detects that the current page (as identified by the URL supplied by the database server) does not in fact display a valid price, then at a step 650 the web browser detects whether the page contains a hyperlink to a page which would display a price, before passing control back to the step 620. Again, the presence of such a hyperlink is by searching for known html strings used by that online shop to indicate such hyperlinks. The hyperlink might be a relatively simple link (for example, a link along the lines of “click here to see our latest price for this item”) in which case the step 650 simply involves following that simple link and applying the step 630 to obtain the price. Alternatively, the link might be more complicated. An example is as follows.

In the example, a price is not provided by the particular online shopping server under consideration until the user has proceeded towards buying that item. So at the step 650, the web browser follows a link identified using the techniques described above as “add to basket” or, in the example shown in FIG. 4, as “add to cart” 670. This places the item into an online shopping basket or cart. The step 650 then identifies a “view basket” link using the same techniques and follows that link, so that the step 630 can scrape the price of the item within the basket. For thoroughness, the web browser can optionally then follow a further link (again, obtained from the html code by the string matching techniques described above) to delete the item from the basket.

A maximum number of retries, that is to say, a maximum number of times that the loop 620-650 can be followed, may be imposed by the web browser. An example maximum number in this context is three. If the system fails to identify a price by the end of the third attempt, price scraping can be aborted in respect of that URL. The way in which failed price scraping processes are dealt with is discussed below with reference to FIG. 9.

The process shown in FIG. 3 is carried out separately in respect of each URL returned to the web browser 190 by the database server 300.

The description above relates to price scraping from a competitor's web page, i.e. a web page other than the page which the user is currently viewing. However, a similar technique is also applied at the steps 520 and 530 to scrape a price from the web page which the user is currently viewing.

FIG. 5 schematically illustrates a part of a user's screen display which is relevant to the description above of the step 540 of FIG. 2.

In embodiments of the invention, the material displayed at the step 540, as the results of the process shown in FIG. 3, is provided as a so-called “iframe” within the browser window 190.

Iframes, or “inline frames”, sometimes referred to as floating frames, are used to embed content into an HTML web page in such a way that the embedded content is displayed inside a subwindow of the web browser. The embedding process does not combine the two html documents together, but instead the content inside the iframe remains independent from the content of the main page in which the iframe is placed.

An iframe html element has the schematic form:

<iframe src=“URL” more attributes> alternative content

</iframe>

The parameter “src” indicates a URL at which the material to be embedded using the iframe may be found. Other attributes are indicated schematically in the representation shown above by the text “more attributes”. The “alternative content” represents textual material for display in case a particular web browser does not support iframes.

In basic terms, the content referenced by the source URL is displayed in a subwindow of the web browser. The “alternative content” is ignored by a web browser which is compatible with iframes.

In the present embodiments, the iframe source material (at the source URL) provides the framework—size, colour scheme, layout, fonts and so on—for rendering the notifications in the step 540. The actual notification data itself, that is, the names and prices from competing online sellers, is generated by at the client side (by the extension software of the web browser), for example at the step 630, so as to populate the framework provided by the iframe source content.

There are several advantages of using iframes in this way, compared to embodiments in which the results notifications at the step 540 are rendered entirely by the client-side web browser.

Firstly, the arrangement allows a more rapid deployment of changes in or updates to the way in which the notifications are rendered. In previous arrangements, any such changes had to be propagated by issuing updated extension code. For example in the case of the Mozilla Firefox browser, a revised extension has to be propagated via the Mozilla extension distribution system. The propagation process could take some time, in part because of the quality control precautions carried out by Mozilla (which can take several days). By using iframes in this way, any changes of this nature can be made to the source content linked to by the iframe definition. So, changes or updates can be propagated substantially instantly.

Secondly, the use of iframes rather than client-side rendering can be arranged so as to provide no visible difference to users of the web browser. That is to say, the window as seen by the user can be the same, whichever of the two systems is used.

Thirdly, the use of iframes in this way allows comparative testing of different notification formats or functionality. This is sometimes referred to as “A/B testing”, though this does not restrict the testing to a comparison of only two alternatives. Reference 5 discusses this technique. This type of testing can be used to test alternative new arrangements against one another, but a potentially safer use is to test proposed upgrades on a subset of users before implementing the upgrade for all users. That type of test would involve testing the success of the proposed upgrade against the ongoing success of the existing content.

The basic idea behind comparative testing in this way is that the content provided as the source material for the iframe referred to above can be changed, between groups of users, on a time division basis, or both. So, for example, one group of users may link to one format of the source content, while another group of users may link to a different format. If the groups of users are large enough to allow statistically significant results to be obtained, then the relative “success” of the two formats in encouraging users to progress from the initial pricing enquiry, to a click-through, to a full purchase can be assessed. It has been postulated that even minor changes to the appearance and/or usability of referral links provided at the step 540 could have a marked effect on the proportion of users who go on to click-through and/or to make a purchase.

Instead of (or as well as) differentiating different trial versions of the source content by group of users, the source content could be varied by time period. However, this has the risk that a single user may see different versions of the notifications provided at the step 540 during a single browser session, which could cause annoyance to the user.

Although the click-through and the purchase rates are commercially very useful assessments of the success or lack of success of a modification to the way in which notifications are rendered, a further measure can be the number of users who actually uninstall the extension software. This is a rather dramatic reaction to a user interface problem, but can still happen. Uninstallations are clearly undesirable for the software provider, as they reduce the consumer base and can lead to damaging information propagating amongst remaining users. Such uninstallations can be monitored as part of the “A/B” testing process described above, for example by means of notifications passed back from the web browser or the Mozilla extension distribution system, and a test system can be withdrawn very quickly if such problems are noted.

A further feature of iframes is that so-called analytics can be inserted into the iframe. Analytics, in this context, are known software functions which are used on many websites (see Reference 6 for example) and which allow the provider of an internet-based service to detect the usage of (and data traffic relating to) that service by the end user. By using analytics, accurate data can be obtained about the usage of the internet services presented by the techniques described in this application.

In other embodiments, the notifications are rendered by software provided as the client side extension.

The example shown in FIG. 5 relates to a user viewing a web page from a particular online shop (in this example a hypothetical shop called example.co.uk) for a particular model of a Sony® MP3 player. The image shown in FIG. 5 represents an upper part of a display window of a web browser 190 on the client computer, and the URL of the specific web page at example.co.uk relating to the current product is shown in an address region 700 of the browser. It is that URL which the browser sends to the database server at the step 500 of FIG. 2. Preferably the URLs are normalised, so opening any of the following example URLs:

http://www.example.com/ipod-touch-16gb
http://example.com/ipod-touch-16gb/
http://www.example.com/ipod-touch-16gb/?referrer=ih&campain=abcd
http://www.example.com/catalogue?product=ipod-touch-16gb

will cause the URLs to be normalized (reduced) to a standard form, e.g. http://www.example.com/ipod-touch-16gb, so the system can identify the product irrespective of the URL used to navigate to it. Similar considerations apply to web addresses constructed using retailer codes (see above).

The actual details of the current product on example.co.uk appear in the display window below the portion shown in FIG. 5. They are omitted from the drawing for clarity, as they are not relevant to the present technical discussion.

The extension to the web browser inserts an iframe providing an additional information “bar” (horizontal region) 710 at the top of the web browser's display window. This information bar provides display space to indicate the price comparison derived at the step 540 in FIG. 2. In general, as each scraped price is obtained (i.e. as the process of FIG. 3 reaches the steps 630 and passes control back to the step 540 of FIG. 2 for each URL) the price comparison information displayed in the information bar 710 is updated so as to show the best price out of those currently identified.

In FIG. 5, one alternative price of £39.99 has been obtained (from a hypothetical online shop called othershop.co.uk), and this alternative price is in fact higher than the price offered by the web page at example.co.uk which the user is currently viewing. So the information bar identifies the alternative offering and provides a hyperlink (via a button 720) to the web page of that alternative offering, but also provides confirmation that the current web page offers the best price out of those for which results have been obtained so far. Note that there is no need for the information bar to display the price as offered by the currently viewed web page, as this price information is in fact given on the currently viewed web page itself.

If a competitor offered a better price then the information bar 710 could display information such as:

“This item is cheaper at [Othershop.co.uk (£31.99)]”

where the square brackets [ ] delimit text to appear on the hyperlink button 720.

If more than one competitor site with a better price has been identified, then the information bar could carry information such as:

“This item is cheaper elsewhere. [Click here for alternatives]”

so that when the user clicks on the hyperlink button 720 a vertical or other list of alternative online shops is provided, with each entry in the list indicating the name of the shop and the price, so that clicking on that name or price activates a hyperlink to the web page of that offering.

The price scraping process described above makes use of so called “regular expressions”or “regexes”.

A regex is a code-snippet (that is, a portion of software code) which tells the client software where to look on retailer product pages for the desired data. An example of a price scraping regex is:
[<span id=“productprice”[\1-\uFFFF]+?\$([\d.,]+)<]

Maintaining regexes is a major development overhead because retailers frequently change the layout of their web pages. Even a subtle alteration to page layout can ‘break’ a regex, which is to say, it stops the regex from detecting the price (or the correct price) on a retailer's web page. A broken regex will return invalid data or fail to return any data at all. This can be a significant problem because:
1. It can be difficult to be sure if a regex was broken
2. It can be time consuming to manually repair the regex

Embodiments of the invention use a self-healing regex system. This can represent a cooperation between the server and the client. In embodiments of the invention, existing regexes are automatically tested on the server-side, for example at predetermined regular intervals. The system applies existing regexes to product pages and detects if a regex returns invalid data or fails to return data at all.

The server-side system has a list of product URLs and a set of matching expectations, for example the price on a certain page should normally be scraped to a value of (say) between £4 and £5. At regular intervals the system will download the html code for each such URL and apply the regexes to the html. The matches (or no matches) found by applying the regexes to the html are then compared to the expectations. If the expectations do not match the findings, the system categorizes the regex/scraper for that website as being broken.

A complementary reporting system can also monitor for broken regexes, by monitoring the number of notifications (of competing suppliers and prices) provided to users at each retailer. If the number of notifications generated in respect of a specific retailer suddenly drops by a large amount (for example, a drop in average value of notifications for that retailer of more than 50% over a time period of less than a day) then this can provide an indication that the scraper relevant to that retailer is no longer working correctly or needs to be updated.

An example of a situation in which such a large and sudden drop may occur is as follows. Sometimes retailers carry out a comparative (“A/B”) test on a new design of their website, so as to compare the response of different groups of users to the proposed changes. A current version of the scraper may work with one of these alternative website designs, but may not work with the other, so a new scraper is required for the newly provided website design.

If a regex is broken, the system will attempt to apply a variety of possible regexes to the product page to see if valid data can be returned. The system has a long list of regexes as different websites generally require different regexes. However, there are often certain similarities between websites; hence sometimes the same regex can be used for multiple websites. By applying regexes used on other websites to a website with a broken regex/scraper, the system can sometimes find that one or more of those other regexes finds results that matches the expectations for that website. If a new working regex is found, the system can then simply replace the old broken regex with the new working one. This is what is referred to as a self-healing regex/scraper.

Client-side, the extension software regularly downloads the current set of regexes from the database server. This happens automatically from the user's point of view, and enables the client-side software to work with the latest regex, even if they change frequently.

This arrangement will now be described in detail with reference to FIGS. 6-8.

Referring to FIG. 6, the steps which lead to the initiation of a regex testing and repair process will be described.

At a step 730, the rate of notifications received in respect of a particular hyperlink (at the step 543 in FIG. 2) is detected. Similarly, at a step 732, the rate at which users are clicking through those hyperlinks is also detected, using the data acquired at the step 553 in FIG. 2. Each of these detected rates, in respect of a particular hyperlink, is compared with a respective threshold value at a step 734.

A timed process 736 also takes place, and generates a signal to instruct a regular testing of the regex data at predetermined intervals, for example every four hours.

At a step 738, the testing and, if appropriate, repair of the regex data is initiated if either of the detected rates (at the steps 730 or 732) is less than its respective threshold value, thereby indicating that the web browsers are struggling to detect prices from the corresponding hyperlinks, or if the timed process 736 indicates that a regular test is due.

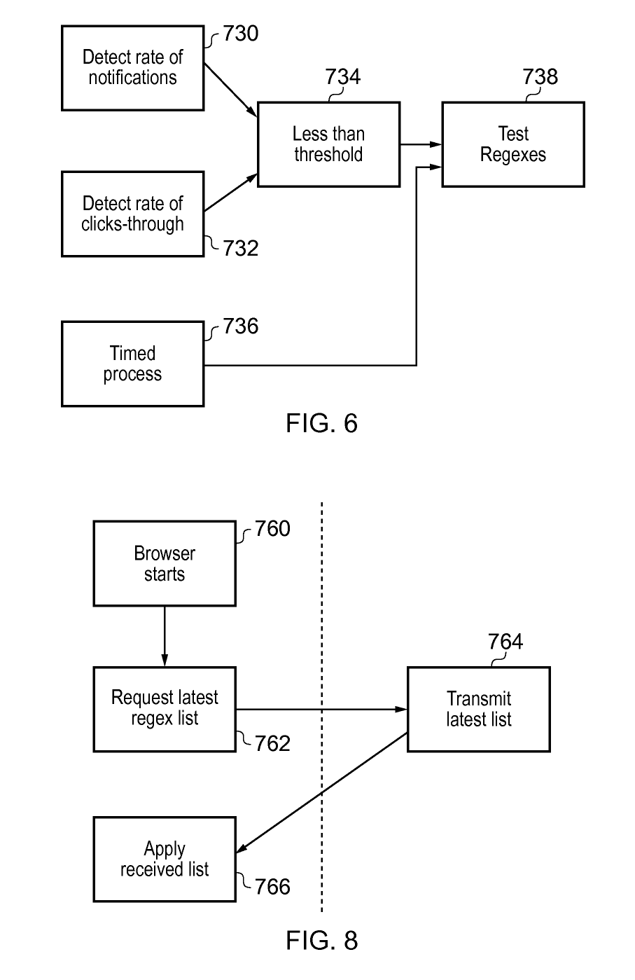

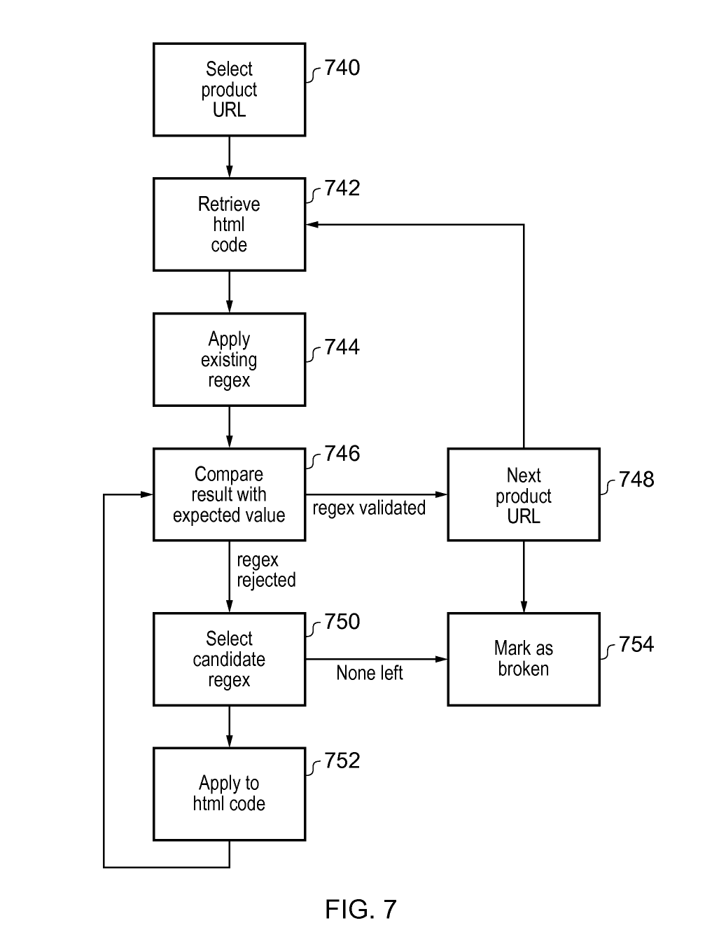

FIG. 7 schematically illustrates a regex testing and repair process.

At a step 740, a product URL is selected for testing. At a step 742, the HTML code relating to the web page defined by that product URL is retrieved from the retailer website.

At a step 744, the existing regex which is currently in use for scraping a price from that page is applied to the retrieved HTML code.

At a step 746, the result, that is to say, the scraped price obtained by applying the existing regex, is compared with an expected value. In fact, the expected value may be expressed as a value plus or minus an error percentage (to allow for price changes). Alternatively, the expected value may be expressed as a range of prices.

If the scraped price falls within the range defined by the expected value, then the regex under test is considered to be validated and the process moves to a next product URL at a step 748.

If, however, either the regex under test fails to produce a scraped price at all, or the scraped price is outside of the range defined by the expected value, then control passes to a step 750 at which a candidate replacement regex is selected. As mentioned above, the candidate replacement regex can be selected from a list of candidate regexes maintained by the database server. The list can be, for example, a set of the most common regex values which are found to apply to other webpages from other retailers, or a set of the most common regex values which are found to apply to all webpages from all retailers, or a set of all regex values from all webpages covered by the database server. The last of these options would be a very long list under normal circumstances, so the former options, in which a set of (for example) 50 most common regex values is used, may provide a more efficient operation of the process. So, whichever list is in use, a next regex from the list is selected at the step 750.

If, at the step 750, there are no remaining regex values from the set available, then at a step 754 the product URL is marked as broken (in the sense that it is unavailable for scraping prices, at least at the moment) and control returns to the step 748. The broken URL can be retained on the database server, however, and an attempt made to apply a regex value to that URL at a later testing process. This is because the reason for the failure of the URL might simply be that the retailer website is temporary closed, for example as part of a maintenance process.

The candidate regex selected at the step 750 is applied to the retrieved HTML code at a step 752, and control returns to the step 746 on the basis of the price scraped using the new candidate regex. As before, if the scraped price is within the expected value range then that new regex is validated and is stored for use with that particular product URL in place of the previous regex value. If, however, the candidate regex is rejected then a next candidate regex is selected at the step 750 and the process repeats until all of the candidate regex values have been tried.

Many of the steps shown in FIG. 7 are also applicable to the establishment of a regex for the first time with a newly acquired product URL. In these circumstances, there is no existing regex so the step 744, and the corresponding first instance of the step 746, do not take place. Instead, control passes from the step 742 directly to the step 750 at which a candidate regex is selected to be tried with the newly acquired or that URL. The process continues as before until a candidate regex is validated by the step 746 or until all of the candidate regex values have been tried and control passes to the step 754.

FIG. 8 schematically illustrates the transmission of regex values to the web browser. In FIG. 8, steps shown to the left side of a broken line are carried out at the web browser, and steps to the right of the broken line are carried out at the database server.

At a step 760, the browser starts. This means that the user initiates the execution of the browser application at the client computer 100. As part of its starting operations, at a step 762 the browser requests the latest regex list from the database server, by sending a message to the database server via the Internet connection 400.

At a step 764, the database server 300 transmits the latest regex list to the browser and, at a step 766, the browser applies the received list to its ongoing operations in respect of the step 520 (price scraping) in FIG. 2.

FIG. 9 is a schematic flow diagram illustrating a referral payment arrangement, otherwise referred to above as an affiliate scheme. Steps carried out at the browser 190 are shown on a top row, and steps carried out at the shopping site are shown on a lower row. (Of course it is appreciated that in any client-server interaction, processes are shared between the client and the server, so the division shown here is purely to assist with the explanation. In fact, to stress this point, the step 560 is shown in FIG. 2 as a server operation and in FIG. 9 as a client operation; in fact it is of course both, and the way it is illustrated is simply chosen in order to assist with explanation).

The hyperlink derived by the web browser at the step 540 not only includes sufficient information to identify the competitor shop and the relevant product page, it also includes data identifying the referrer, which in this case is the provider of the extension software (i.e. not the user himself). So at a schematic level the hyperlink might look like: www.other_shop.co.uk/?product=product_name&referrer=extension_software_provider_ID

The referrer information is invisible to the user. This doesn't mean that the user is prevented from seeing it, but rather that it generally has no effect, from the user's point of view, on the web page to which the user is redirected when he clicks on the hyperlink. Rather, the referrer information is simply used by the competitor web page (or an affiliate network) to collect information regarding the referrer.

Returning to FIG. 9, the step 550 discussed above involves the user selecting a hyperlink prepared (in the form just described) at the step 540. From there, control passes to the step 560 and to a step 800. At the step 800 the online shopping server currently accessed by the user records details of the referrer, as derived from the hyperlink used to access that server, and passes those details to a step 820. In other embodiments, not shown, an affiliate network could stand between the user and the online shop, with the affiliate network recording details of the purchase but allowing the shop to handle the actual purchasing process.

If the user decides to make a purchase at the step 560, then at a step 810 the online shopping server records details of that sale against the particular referrer, and again passes this information to the step 820.

At the step 820, the provider of the online shopping server pays the referrer for the referrals. This could be in the form of a small payment for each shopper who is referred on to the online shopping server. This type of payment is sometimes referred to as a click-through payment. Another form of payment is a commission on the actual sale. Such commissions are generally much larger than click-through payments. In some cases both types of payments can be provided.

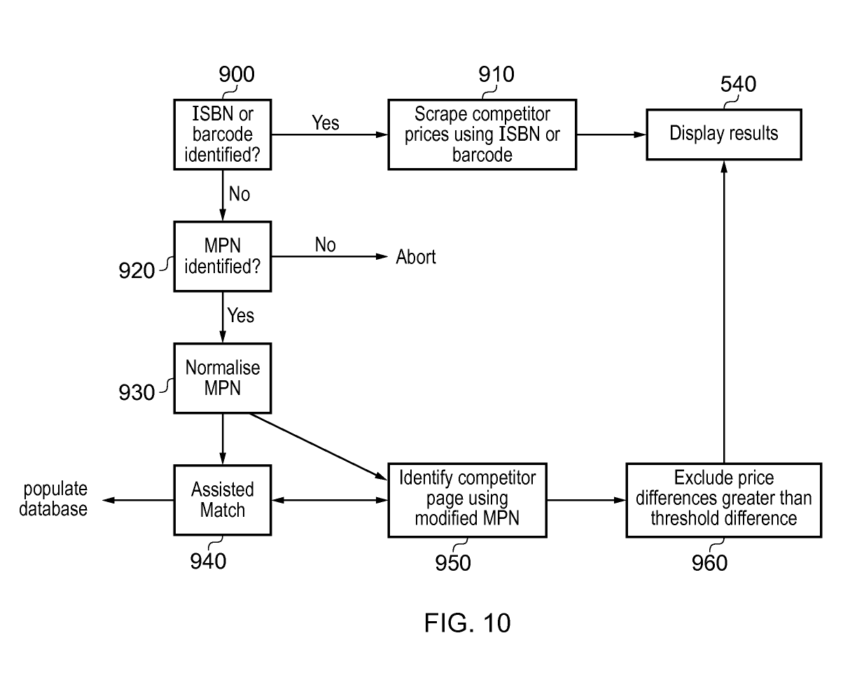

FIG. 10 is a schematic flow diagram illustrating a product identification process. This process applies in the instance that the browser 190 sends to the database server (at the step 500) a URL which is not recognised as such (i.e. it is not in one of the groups in the database) but the retailer to which that URL belongs is recognised by the database server (that is to say, the retailer is one of a list of retailers for which the database server stores URLs).

At a step 900, the current page and/or URL is scraped by the web browser to identify a possible unique identifier such as a barcode or ISBN identifier. If that is successful, then at a step 910 competitor prices can be obtained via that identifier. For example, a competitor website might have one possible standard URL format as:
www.other_example.co.uk/ISBN=1234567891
   so that a URL for that competitor can be built (as described above in the “on the fly” system) without having to find the URL in a database (alternatively, the ISBN number can be sent back to the database server which provides a derived URL for that product). If a price is successfully scraped from the built URL, that URL can itself be sent to the database server as a query to see whether it can be found in a group, and so on. Control then passes to the step 540 for the results to be displayed as before.

If however a unique identifier cannot be obtained, then at a step 920 the current page is scraped for a manufacturer product number (MPN). This is a more ambiguous identification, because MPNs appear in many different forms, such as with and without spaces, and with and without punctuation. So for example the following might all refer to the same product:

TCB-321-X

TCB321X

TCB 321 (x)

If an MPN cannot be obtained then the process is aborted. However, if an MPN is found then at a step 930 it is “normalised” (which could take place at the extension software, but preferably takes place at the database server), which means removing any spaces and punctuation, and expressing all characters in the same case (e.g. upper case).

The MPN can then be used in the same way as the unique identifier mentioned above, to find a competitor's page offering that product at a step 950. The brand of the item can also be used as additional confirmation of the validity of the match by checking that both items have the same brand. Because of the ambiguity involved in the use of normalised MPNs, optionally, an assisted match process can be carried out at a step 940. This could involve passing the details which have been generated automatically to a real-time human operator known as a “Mechanical Turk” (see Reference 2) to confirm whether the match is correct. Having said this, the present embodiments do not make use of the Mechanical Turk system.

Prices are then obtained as described above, but at a step 960 any prices which have more than a threshold difference (e.g. a 50% difference) from the price on the currently viewed page are excluded, as these may well indicate poor matches. Control then returns to the step 540.

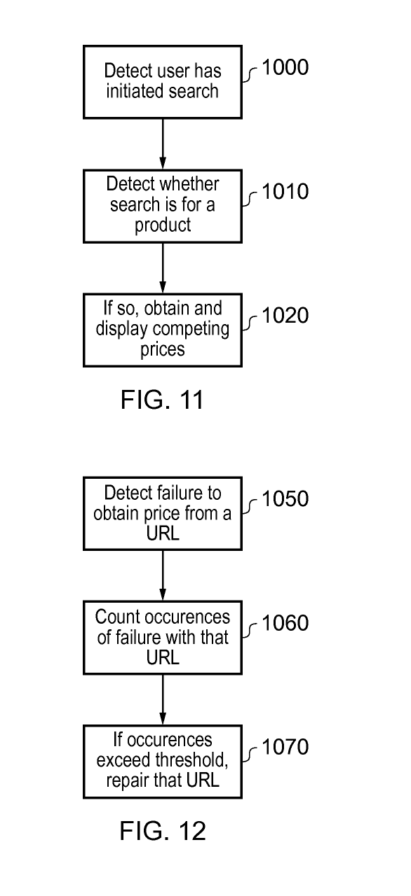

FIG. 11 is a schematic flow diagram illustrating a price comparison process relating to search results. This is a way of linking the real time price comparison functionality described above to the search results generated by a conventional search engine run within the web browser 190. This technique is not limited to search sites only. For example, it can be carried out with respect to product review sites. If the user is browsing a page with a review of Nikon® D3000™ camera, they may well be willing to buy it, so the system may show the list of prices.

At a step 1000, the web browser detects (from the current URL being accessed) that the user has initiated a search for a particular item. Here it is noted that the current URL not only indicates that a search engine is in use, but also the keywords which are being searched. So the URL relating to a search query may follow the general form:
www.search_engine_name.com/query=“DVD Brief Encounter”

From this URL, the web browser can extract at a step 1010 that the user is searching for a DVD of the film “Brief Encounter”. Using this information, the web browser applies the processing described above to identify prices for that particular product at a step 1020. However, in order to do this, certain additional features are required.

The first additional feature is that the product identified in the search engine URL must be linked to a URL or a group of URLs generated by the database server or in the database held by the database server 300. There are various ways in which this can be done. Perhaps the most straightforward is as follows:

(a) the web browser examines the list of citations provided by the search engine

(b) if one of those citations is for a product at a particular predefined online retailer (or the highest ranked citation from one of a predefined set of online retailers) then the web browser uses the URL of that search citation as a query (step 500) to the database server 300. In this instance, the step 540 will include displaying all of the group of URLs as affiliate hyperlinks, including the one identified as the search query to the database server 300. Even if the URL is not part of a group of URLs, it can still be displayed alone.

This technique conveniently allows the search engine and the particular online retailer to carry out the relatively hard task of identifying a particular product from what may be an ill-defined search term initially typed by the user.

Another possibility is that the database held by the database server 300 includes keywords for each group of URLs. The web browser sends the search terms (rather than the current URL) to the database server in the step 500, and known keyword matching techniques are used by the database server to identify the group of URLs most relevant to those search terms. As a further refinement of this technique, the web browser can detect, before implementing this modified version of the step 500, whether the search engine has raised any citations (or any citations in the top n citations, where n might equal 5) which relate to price comparison or online shopping sites. If not, then the web browser assumes that the current search is not a search for a product, and so takes no action.

Another possibility is that the database held by the online shop database 200 includes keywords for each group of URLs. The web browser sends the search terms (rather than the current URL) to the online shop database, and known keyword matching techniques are used by the database server to the most relevant product. This product URL is then submitted to the database server in the step 500 to derive the URLs of competitors' offerings of the same product.

As a further refinement of this technique, the web browser can detect, before implementing this modified version of the step 500, whether the search engine has raised any citations (or any citations in the top n citations, where n might equal 5) which relate to price comparison or online shopping sites. If not, then the web browser assumes that the current search is not a search for a product, and so takes no action. This effectively describes our method of submitting keywords to a shopping site's application programming interface (API) (not to the system's own server) so that it can try to find a match. An additional variation is also possible: rather than simply submitting the user-entered keyword string to the shopping site API, the system can scrape the first x words of the first product/shopping result from a search engine and submit these to the shopping site API. Finally, FIG. 12 is a schematic flow diagram illustrating a process for handling failed price scraping operations, as an alternative to that shown in FIG. 7. At a step 1050, the web browser 190 detects a failure to obtain a price from a URL supplied by the database server at the step 510. The failure could relate to the fact that the web page identified by that URL no longer exists, or that even after a maximum number of followed links (the step 650) a price cannot be identified, or simply that after a threshold time (e.g. ten seconds) it had not been possible to obtain a price from that URL. Another common reason scrapings fail is that the html layout is changed by the retailer. The web browser communicates this failure to the database server.

At a step 1060, the database server increments a count of failed attempts relevant to that URL. The counts for each URL are compared to a threshold count at a step 1070. If the count for a particular URL exceeds the threshold, then a repair process can be initiated for the regex corresponding to that URL as described above. Or that URL can be deleted from the database held by the database server 300. In other embodiments, the counter alone is not sufficient to delete a URL. Consider an example in which there is a popular product at a popular retailer and that retailer changes the html layout, so the scrapers fail on that product (and all others) The counter will have a high value but it would be wrong to delete that URL because it is actually valid.

Instead, the system may take into account the relative number of failures for this retailer and delete the URL only if its failure counter is high while the overall failure counter for the retailer is low. If this results in a group now holding only one remaining URL, then optionally the database server can delete the one remaining URL in that group.

In summary, therefore, the database server (or another part of the system) provides a testing system configured to apply the regular expression to its respective online retailer internet page to extract a product price and to detect whether the extracted product price lies within the expected price range corresponding to that online retailer internet page; the testing system being configured, in the case that the extracted product price does not lie within the expected price range, to allocate a different regular expression, from a group of candidate regular expressions, to that online retailer internet page and to repeat the test using successive regular expressions from the group of candidate regular expressions.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

As an example of a possible modification, the copy of the database to which the browser refers in the step 500 need not be held by the database server; a primary copy could be held by the browser, and just updated from time to time by the database server.

### REFERENCES

Reference 1: http://en.wikipedia.org/wiki/Add-on_(Mozilla)—as retrieved on 28 Oct. 2011
Reference 2: https://www.mturk.com/mturk/welcome—as retrieved on 28 Oct. 2011
Reference 3: http://www.nytimes.com/2010/02/08/technology/internet/08price.html as retrieved on 28 Oct. 2011
Reference 4: U.S. patent application Ser. No. 12/731,025 by Shadchnev and Landy, filed on 24 Mar. 2010.
Reference 5: http://visualwebsiteoptimizer.com/split-testing-blog/a-b-testing-browser-extension/, as retrieved on 28 Oct. 2011.
Reference 6: http://www.google.com/intl/en_uk/analytics/, as retrieved on 28 Oct. 2011.

1. A data processing system comprising:
a database configured to store a set of internet addresses of online retailer internet pages and associated respective regular expressions each defining a code string, relative to code representing an online retailer internet page at a corresponding internet address in the set, for extracting a product price from that online retailer internet page, and a respective expected price range associated with each online retailer internet page in the set; and
a testing system configured to apply the regular expression to its respective online retailer internet page to extract a product price and to detect whether the extracted product price lies within the expected price range corresponding to that online retailer internet page;
the testing system being configured, in the case that the extracted product price does not lie within the expected price range, to allocate a different regular expression, from a group of candidate regular expressions, to that online retailer internet page and to repeat the test using successive regular expressions from the group of candidate regular expressions.

2. A data processing system according to claim 1, in which the testing system is configured to replace a regular expression associated with an internet address by a candidate regular expression for which the extracted product price lies within the expected price range corresponding to that online retailer internet page.

3. A data processing system according to claim 1, in which the group of candidate regular expressions comprises regular expressions associated with others of the set of online retailer internet pages provided by the database.

4. A data processing system according to claim 3, in which the group of candidate regular expressions comprises a group of most common regular expressions associated with others of the set of online retailer internet pages provided by the database.

5. A data processing system according to claim 1, comprising:
a client device connectable to the database, the client device having a web browser for accessing information via the internet;
the web browser being configured to access the set of internet addresses of online retailer internet pages, the set being arranged as subsets each having two or more internet addresses each relating to different respective retailers' offerings of an item for purchase, so that if information derived from a current internet address being accessed by the web browser relates to such a subset of internet addresses, the other internet addresses in the group are returned by the database as alternative internet addresses relating to a current item being viewed;
the web browser being configured to detect a retail price of the current item from each of the internet addresses in the subset using the respective regular expression associated with each such internet address; and
the web browser being configured to compare the retail prices and indicate the lowest such retail price for the current item while displaying the internet page relating to the current internet address.

6. A data processing system according to claim 5, in which the web browser is operable to provide one or more competitor hyperlinks to at least the internet page relating to the lowest priced offering of the current item.

7. A data processing system according to claim 6, in which the one or more competitor hyperlinks each include an identification of a provider of at least a part of the web browser software in use on the client device.

8. A data processing system according to claim 6, in which the web browser is configured to display the one or more competitor hyperlinks in an inline HTML frame using inline frame formatting information obtained from a formatting information server.

9. A data processing system according to claim 8, in which the formatting information server is configured to provide two or more different versions of the inline frame formatting information.

10. A data processing system according to claim 9, in which the system is configured to detect the frequency of users selecting one of the one or more competitor hyperlinks, for each of the two or more versions of the inline frame formatting information.

11. A data processing system according to claim 10, in which the formatting information server is configured to provide the different versions of the inline frame formatting information to different respective groups of users.

12. A data processing system according to claim 5, in which the web browser is configured to detect whether any internet addresses in the subset fail to provide price information using the respective regular expression.

13. A data processing system according to claim 12, in which the web browser is configured to notify the database any internet addresses in the subset fail to provide price information using the respective regular expression.

14. A data processing system according to claim 13 in which, for an internet addresses notified by the web browser as failing to provide price information using the respective regular expression, the testing system is configured to allocate a different regular expression to that internet address.

15. A data processing method comprising:
a database providing a set of internet addresses of online retailer internet pages for association with respective regular expressions each defining a code string, relative to code representing an online retailer internet page at a corresponding internet address in the set, for extracting a product price from that online retailer internet page, and a respective expected price range associated with each online retailer internet page in the set;
a testing system applying the regular expression to its respective online retailer internet page to extract a product price and to detect whether the extracted product price lies within the expected price range corresponding to that online retailer internet page; and
in the case that the extracted product price does not lie within the expected price range, the testing system allocating a different regular expression, from a group of candidate regular expressions, to that online retailer internet page and to repeat the test using successive regular expressions from the group of candidate regular expressions.

16. A data processing system comprising:
a client device having a web browser for accessing information via the internet; and
a formatting information server;
the web browser being configured to access a set of one or more internet addresses of competitor online retailer internet pages in response to a user browsing an internet page relating to a current item for potential purchase, and to detect a retail price of the current item from each of the internet addresses in the set using a respective regular expression associated with each such internet address;
the web browser being configured to provide one or more competitor hyperlinks to at least the competitor internet page relating to the lowest priced offering of the current item and to display the one or more competitor hyperlinks in an inline HTML frame using inline frame formatting information obtained from the formatting information server; and
the formatting information server being configured to provide two or more different versions of the inline frame formatting information.

17. A data processing system according to claim 16, in which the system is configured to detect the frequency of users selecting one of the one or more competitor hyperlinks, for each of the two or more versions of the inline frame formatting information.

18. A data processing system according to claim 17, in which the formatting information server is configured to provide the different versions of the inline frame formatting information to different respective groups of users.

19. A data processing system according to claim 16, in which the web browser includes one or more extension modules.

20. A data processing method comprising:
a web browser of a client device accessing a set of one or more internet addresses of competitor online retailer internet pages in response to a user browsing an internet page relating to a current item for potential purchase, and detecting a retail price of the current item from each of the internet addresses in the set using a respective regular expression associated with each such internet address;
the web browser providing one or more competitor hyperlinks to at least the competitor internet page relating to the lowest priced offering of the current item and displaying the one or more competitor hyperlinks in an inline HTML frame using inline frame formatting information obtained from a formatting information server; and the formatting information server providing two or more different versions of the inline frame formatting information.
